(19) United States
(12) Patent Application Publication
(10) Pub. No.: US 2014/0264127 A1
(43) Pub. Date: Sep. 18, 2014

(54) VALVE DEVICE

(71) Applicant: DENSO CORPORATION, Kariya-city (JP)

(72) Inventor: Shinichi Yokoyama, Gifu-city (JP)

(73) Assignee: DENSO CORPORATION, Kariya-city (JP)

(21) Appl. No.: 14/153,385

(22) Filed: Jan. 13, 2014

(30) Foreign Application Priority Data
Mar. 14, 2013 (JP) 2013-51435

(51) Int. Cl. F16K 5/06

(52) U.S. Cl. CPC F16K 5/06
USPC 251/315.16

(57) ABSTRACT

A passage forming portion has a first opening of a first passage. A valve element has a second passage of a second opening and a slidable surface slidable relative to an opening periphery of the first opening. The valve element rotates to increase an overlap region, in which the first opening overlaps with the second opening, to communicate the first passage with the second passage to increase a flow quantity of fluid between the first passage and the second passage. A flow quantity retention unit is equipped in the valve element to retain the flow quantity constantly regardless of a rotation angle in a range from an angle, at which the slidable surface starts to open the first opening, to a predetermined rotation angle.

### CROSS REFERENCE TO RELATED APPLICATION

This application is based on reference Japanese Patent Application No. 2013-51435 filed on Mar. 14, 2013, the disclosure of which is incorporated herein by reference.

### TECHNICAL FIELD

The present disclosure relates to a valve device configured to open and close a passage.

### BACKGROUND

For example, Patent Document 1 discloses a conventional valve device. As shown in FIGS. 8 and 9, a valve device 100 includes a valve element 102 and a valve seat 104. The valve element 102 has a passage 101 therein and rotatable around a predetermined rotation axis thereby to change the direction of the passage 101. The valve seat 104 forms a passage 103. The passage 103 is communicated with the passage 101, and the passage 103 is blocked from the passage 101. This valve device 100 transits from a valve-close state to a valve-open state with rotation of the valve element 102. In the valve-close state, the opening 105 of the passage 103 is blocked by the surface of the valve element 102. In the valve-open state, the surface of the valve element 102 releases the opening 105, and the opening 105 and the opening 107 of the passage 101 overlap one another. Subsequently, as the rotation angle further increases, an overlap area (communicated opening area A) between the opening 105 and the opening 107 increases. Thus, as shown in FIGS. 8 and 10, a flow quantity of fluid flowing between the passage 101 and the passage 103 increases.

In the configuration of the valve device 100, the communicated opening area A largely changes, as the rotation angle changes, in a range (small opening range), in which the rotation angle is small, and the valve opening starts. That is, in the small opening range, change in the flow quantity is large, as the rotation angle changes. In particular, in the configuration shown in FIG. 8, the opening 107 is in a circular hole shape, and the flow quantity largely changes, as the rotation angle changes in the small opening range.

(Patent Document 1)

Publication of an unexamined German patent application No. 10 2009 014 047

A valve device is demanded to control a flow quantity with high accuracy in a small opening range. It is noted that, variations exist in various factors. For example, a variation exists in a dimension of a component, and a variation exists in an output characteristic of a sensor, which is for detecting the rotation angle of the valve element. Due to such variations, a variation occurs in the rotation angle. In the above-described configuration, as the rotation angle changes in the small opening range, a flow quantity largely changes. In the configuration, as shown in FIG. 10, the flow quantity varies largely due to a variation in the rotation angle. Therefore, the configuration hardly controls the flow quantity with a high accuracy.

It is an object of the present disclosure to produce a valve device configured to control a flow quantity with a high accuracy in a small opening range.

### SUMMARY

According to an aspect of the present disclosure, a valve device comprises a passage forming portion forming a first passage and having a first opening of the first passage. The valve device further comprises a valve element having a slidable surface, which is slidable relative to an opening periphery of the first opening, and a second passage, which has a second opening in the slidable surface and is communicable with the first passage. The valve element is rotatable around a rotation axis to transit from a valve-close state, in which the slidable surface blocks the first opening to block the first passage from the second passage, to a valve-open state, in which the slidable surface opens the first opening to communicate the first passage with the second passage. The valve element is configured to rotate to increase an overlap region, in which the first opening and the second opening overlap one another, to increase a flow quantity of fluid flowing between the first passage and the second passage. The valve device further comprises a flow quantity retention unit equipped in the valve element and configured to retain the flow quantity constantly regardless of a rotation angle in a range from an angle, at which the slidable surface starts to open the first opening, to a predetermined rotation angle.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a configuration of an engine cooling apparatus equipped with a valve device according to an embodiment of the present disclosure;

FIG. 2 is a schematic view showing a configuration of the valve device according to the embodiment;

FIG. 3A is a perspective view showing a valve element of the valve device, and FIG. 3B is a partial sectional view showing the valve element, according to the embodiment;

FIGS. 4A to 4C are perspective views each showing the valve device, which is rotating, according to the embodiment;

FIG. 5 is a graph showing a relation between a rotation angle and a flow quantity according to the embodiment;

FIG. 6 is a perspective view showing a valve element according to a comparative example;

FIG. 7 is a graph showing a relation between a rotation angle and a flow quantity according to the comparative example;

FIG. 8 is a perspective view showing a valve device according to a prior art;

FIG. 9 is a perspective view showing a valve element according to the prior art; and

FIG. 10 is a graph showing a relation between a rotation angle and a flow quantity according to the prior art.

### DETAILED DESCRIPTION

As follows, embodiments of the present disclosure will be described with reference to drawings.

### Embodiment

### Configuration of Embodiment

A configuration of an engine cooling apparatus 2 will be described with reference to FIG. 1. A valve device 1 according to the present embodiment is employed in the engine cooling apparatus 2. The engine cooling apparatus 2 includes a cooling water circuit. The cooling water circuit forcedly circulates cooling water through the engine 3 thereby to cool the engine 3.

The cooling water circuit is configured to circulate cooling water, which is discharged from a water pump 4, through the engine 3, a radiator 5, and the water pump 4, in this order. The cooling water is a thermal medium such as long life coolant (LLC) including ethylene glycol as a main component.

The engine 3 includes a cylinder head 6 and a cylinder block 7. Each of the cylinder head 6 and the cylinder block 7 has a water jacket 8 configured to flow cooling water therethrough.

The cooling water circuit includes the valve device 1 configured to control a flow quantity of cooling water. In the present embodiment, the valve device 1 is equipped to an outlet passage 11 (FIG. 2), which is connected to an outlet of the water jacket 8. The valve device 1 according to the present embodiment includes a valve element 13 and a valve seat (passage forming portion) 14. The valve element 13 is in a spherical shape. The valve seat 14 is located on the downstream side of the valve element 13.

The valve seat 14 is in a tubular shape extending along an axial direction, which is substantially in parallel with a flow direction of cooling water in the outlet passage 11. The valve seat 14 has a tubular portion defining a passage (valve seat side passage) 16 therein.

The valve seat 14 has one end in the axial direction, and the one end has an opening (valve seat side opening) 17 opened and closed by the valve element 13. The valve seat side opening (first opening) 17 has an opening periphery 18, which has a seat surface on which the valve element 13 is rotatable. The valve element 13 is in surface contact with the seat surface and slidable on the seat surface. The valve seat 14 is urged from a spring 14a and biased to the valve element 13. Thus, the valve seat 14 is in contact with the valve element 13 water-tightly. In the present embodiment, the valve seat side opening 17 is substantially in a circular shape.

The valve element 13 is a ball valve, which is substantially in a ball shape. The valve element 13 is fixed to an end of the shaft 20, which is rotatable around a rotation axis. The rotation axis extends in a direction perpendicular to the axial direction of the valve seat 14.

The valve element 13 has a slidable surface 22, an opening (valve element side opening) 23, and a passage (valve element side passage) 24. The slidable surface 22 is substantially in a spherical shape and slidable on the opening periphery 18. The valve element side opening (second opening) 23 is formed in the slidable surface 22. The valve element side passage (second passage) 24 is communicable with the valve seat side passage (first passage) 16. The valve element side passage 24 is communicable with the outlet passage 11. The valve element 13 is configured to switch a state, in which the valve seat side passage 16 is blocked from the outlet passage 11, and a state in which the valve seat side passage 16 communicates with the outlet passage 11 through the valve element side passage 24.

The valve element side passage 24 extends through the valve element 13 in a direction perpendicular to the rotation axis of the valve element 13. In the present embodiment, the valve element 13 has a U-shaped notch to form the valve element side passage 24, such that the valve element side passage 24 extends through the valve element 13 in the direction perpendicular to the rotation axis of the valve element 13. In the present embodiment, the valve element 13 is a hollow member substantially in a spherical shape. Therefore, the interior of the valve element 13 entirely forms the valve element side passage 24.

The valve element side passage 24 is not limited to the present example and may employ various configurations. The valve element 13 may be, for example, a solid spherical member. In this case, the valve element side passage 24 may be a through hole extending through the valve element 13. Alternatively, the valve element 13 may be a solid spherical member, and a U-shaped notch may be formed in the valve element 13, similarly to the present example, thereby to form the valve element side passage 24.

As the valve element 13 rotates, the state transits from a valve-close state to a valve-open state. In the valve-close state, the slidable surface 22 closes the valve seat side opening 17 thereby to block the valve seat side passage 16 from the valve element side passage 24. In the valve-open state, the valve seat side opening 17 is opened relative to the slidable surface 22.

In the valve-close state, the valve seat side passage 16 is blocked from the outlet passage 11. In the valve-open state, the valve seat side passage 16 is communicated with the outlet passage 11 through the valve element side passage 24. As the valve element 13 further rotates, an overlap area, in which the valve seat side opening 17 and the valve element side openings 23 overlap one another, increases. In this way, a flow quantity of cooling water circulating between the valve seat side passage 16 and the valve element side passage 24 increases.

(Feature of Embodiment)

The valve device 1 according to the present embodiment has a flow quantity retention unit equipped in the valve element 13. The flow quantity retention unit is configured to retain (maintain) a flow quantity substantially at a constant quantity regardless of the rotation angle, when the rotation angle is in an angular range from a rotation angle, at which the valve starts to open, to a predetermined rotation angle. In the present embodiment, the flow quantity retention unit is a groove 30. The groove 30 is formed on the slidable surface 22 and connected with the valve element side opening 23. The groove 30 extends linearly in a rotative direction of the valve element 13. The groove 30 has a constant cross-sectional area throughout the total length of the groove 30.

The valve element 13 opens when rotating to a rotative-directional one side, and closes when rotating to a rotative-directional other side. The groove 30 is formed on an opening periphery 31 of the valve element side opening 23, which is located on the rotative-directional one side. The groove 30 extends linearly from a tip end of the valve element side opening 23, which is located on the rotative-directional one side, toward the rotative-directional one side.

The groove 30 has a cross-sectional area, which is perpendicular to the rotative direction, and the cross-sectional area is substantially constant throughout the total length of the groove 30. The cross-sectional area of the groove 30 is set at a predetermined area to produce a minute flow quantity of cooling water. In the present embodiment, the groove 30 is formed to extend linearly in a direction perpendicular to the rotation axis. It is noted that, the groove 30 may be formed to extend in a direction inclined relative to the direction perpendicular to the rotation axis.

As shown in FIG. 3B, the groove 30 of the present embodiment has the cross section substantially in a semicircular shape. It is noted that, the cross section of the groove 30 is not limited to the semicircular shape and may be in a rectangular shape, a triangular shape, a half-elliptical shape, or the like.

As follows, an effect of the valve device according to the present embodiment will be described with reference to FIGS. 4A to 4C. As shown in FIG. 4A, the valve device 1 is in the valve-close state, in which the valve seat side opening 17 is blocked by the slidable surface 22 of the valve element 13.

Subsequently, as shown in FIG. 4B, when the rotation angle is in the angular range (small opening range) from the rotation angle, at which valve opening starts, to the predetermined rotation angle, the groove 30 first opens to the valve seat side opening 17, prior to the valve element side opening 23. Thus, cooling water flows from the valve element side passage 24 through the groove 30 into the valve seat side passage 16.

When the valve element 13 further rotates to increase the rotation angle, as shown in FIG. 4C, the valve element side opening 23 and the valve seat side opening 17 overlap one another. As the valve element 13 further rotates, the overlap area between the valve element side opening 23 and the valve seat side opening 17 increases.

As shown in FIG. 5, a region J represents the flow quantity in a small opening range when the valve element 13 is in the state of FIG. 4B. In the region J, the flow quantity is determined by the cross-sectional area of the groove 30. Therefore, in the region J, the flow quantity is retained constantly regardless of change in the rotation angle. The region K in FIG. 5 corresponds to the state of FIG. 4C, in which the overlap area between the valve element side opening 23 and the valve seat side opening 17 increases, as the rotation angle increases. Thus, in the region K, the flow quantity increases.

(Effect of Embodiment)

According to the present embodiment, when the valve element 13 is in the small opening range, the flow quantity is retained at the predetermined flow quantity, regardless of the rotation angle. In the present configuration, the predetermined flow quantity can be produced steadily in the low flow quantity region, even when the rotation angle of the valve element 13 varies. That is, the present configuration enables to produce a desired flow quantity regardless of the rotation angle, when the valve element 13 is in the small opening range. Thus, the present configuration enables to control the flow quantity with high accuracy, when the valve element 13 is in the small opening range.

As follows, a comparative example will be described with reference to FIGS. 6 and 7. As shown in FIG. 6, the valve element 13 according to the comparative example has a small opening 40 on the valve element side opening 23. The small opening 40 is substantially in a triangular shape and located on the rotative-directional one side of the valve element side opening 23. The small opening 40 is formed to reduce change in the flow quantity accompanied with change in the rotation angle when the valve element 13 is in the small opening range. The small opening 40 extends through the wall of the valve element 13. The opening area of the small opening 40 increases gradually from the rotative-directional one side to the rotative-directional other side.

According to the comparative example, when the valve element 13 is in the small opening range, an increasing rate of the flow quantity relative to increase in the rotation angle is smaller compared with the conventional examples shown in FIGS. 8 to 10. Therefore, the comparative example enables to reduce variation in the flow quantity accompanied with change in the rotation angle. Nevertheless, as shown in FIG. 7, in the comparative example, a slight variation may be observed in the flow quantity. Thus, the comparative example may hardly control the flow quantity at a desired flow quantity by controlling the rotation angle when the valve element 13 is in the small opening range.

To the contrary, according to the present embodiment, when the valve element 13 is in the small opening range, the flow quantity does not change substantially, and the flow quantity is constant substantially relative to increase in the rotation angle.

Therefore, the cross-sectional area of the groove 30 may be determined such that the present flow quantity becomes the desired flow quantity. Thus, the present embodiment enables to control the flow quantity at the desired flow quantity when the valve element 13 is in the small opening range.

(Modification)

In the present embodiment, the valve element 13 is a ball valve, which is substantially in a ball shape. The valve element 13 is not limited to a ball valve and may be a tubular valve having a tubular surface rotatable and slidable on the valve seat 14.

In the present embodiment, the groove 30 functions as the flow quantity retention unit. It is noted that, the flow quantity retention unit is not limited to the groove 30. The flow quantity retention unit may be, for example, a small passage. In this case, the small passage has an opening on the rotative-directional one side relative to the valve element side opening 23, and the small passage communicates with the valve element side passage 24 or the outlet passage 11. The opening of the small passage is set to be sufficiently small relative to the valve seat side opening 17. When the opening of the small passage entirely opens to the valve seat side opening 17, regardless of the rotation of the valve element 13, the flow quantity is retained constantly at a predetermined flow quantity according to the cross-sectional area of the small passage, during the small passage opens to the valve seat side opening 17.

As described above, according to the present disclosure, the valve device includes a passage forming member, the valve element, and the flow quantity retention unit. The passage forming portion forms the predetermined passage (valve seat side passage) and has the opening (valve seat side opening) of the valve seat side passage.

The valve element has the slidable surface, which is slidable relative to the opening periphery of the valve seat side opening. The valve element further has the passage (valve element side passage) having the opening (valve element side opening) on the slidable surface and communicable with the valve seat side passage. The valve element is rotatable around the predetermined rotation axis to transit from the valve-close state to the valve-open state. In the valve-close state, the slidable surface blocks the opening, and the valve seat side passage is blocked from the valve element side passage. In the valve-open state, the slidable surface opens the opening, and the valve seat side passage is communicated with the valve element side passage. The valve element is rotatable to increase the overlap area, in which the valve seat side opening and the valve element side opening overlap one another, to increase the flow quantity of fluid flowing between the valve seat side passage and the valve element side passage.

The flow quantity retention unit is equipped in the valve element. In the range from the rotation angle, at which valve opening starts, to the predetermined rotation angle, the flow quantity retention unit is configured to retain the flow quantity constantly regardless of the rotation angle.

That is, according to the present disclosure, regardless of the rotation angle, the flow quantity is retained at the predetermined flow quantity in the range (small opening range) from the start of the valve opening to the predetermined rotation angle. The present configuration enables to produce the predetermined flow quantity steadily in the low flow quantity region, even when the rotation angle has a variation. That is, the configuration of the present disclosure enables to retain the flow quantity at the desired flow quantity in the small opening range, regardless of the rotation angle. Thus, the present configuration enables to control the flow quantity with a high accuracy in the small opening range.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A valve device comprising:
a passage forming portion forming a first passage and having a first opening of the first passage;
a valve element having a slidable surface, which is slidable relative to an opening periphery of the first opening, and a second passage, which has a second opening in the slidable surface and is communicable with the first passage, wherein
the valve element is rotatable around a rotation axis to transit from a valve-close state, in which the slidable surface blocks the first opening to block the first passage from the second passage, to a valve-open state, in which the slidable surface opens the first opening to communicate the first passage with the second passage, wherein
the valve element is configured to rotate to increase an overlap region, in which the first opening and the second opening overlap one another, to increase a flow quantity of fluid flowing between the first passage and the second passage; and
a flow quantity retention unit equipped in the valve element and configured to retain the flow quantity constantly regardless of a rotation angle in a range from an angle, at which the slidable surface starts to open the first opening, to a predetermined rotation angle.

2. The valve device according to claim 1, wherein
the flow quantity retention unit is a groove formed on the slidable surface and connected to the second opening, and
the groove extends linearly in a rotative direction and has a constant cross-sectional area throughout a total length of the groove.
